(19) United States
(12) Patent Application Publication
(10) Pub. No.: US 2009/0052658 A1
(43) Pub. Date: Feb. 26, 2009

(54) DESCRAMBLING CIRCUIT, ERROR DETECTION CODE CALCULATING CIRCUIT AND SCRAMBLING CIRCUIT

(75) Inventors: Kunihiko Kodama, Yokohama-Shi (JP); Tomoyuki Maekawa, Fujisawa-Shi (JP); Makoto Takita, Yokohama-Shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/195,582

(22) Filed: Aug. 21, 2008

(30) Foreign Application Priority Data
Aug. 21, 2007 (JP) 2007-215049

(51) Int. Cl. H04L 9/14; G06F 11/10

(52) U.S. Cl. 380/28; 714/699; 714/E11.032

(57) ABSTRACT

A descrambling circuit includes three or more scramble value generators, each configured to generate a new scramble value by a formula at a state of shifting number of times different from each other by every eight bits based on a predetermined generator polynomial, a scramble value generated by the generator polynomial, and a descramble unit configured to descramble partially discontinuous scrambled input data by using the scramble values generated by the three or more scramble value generators.

### CROSS REFERENCE TO RELATED APPLICATIONS

This application is based upon and claims the benefit of priority from the prior Japanese Patent Application No. 2007-215049, filed on Aug. 21, 2007, the entire contents of which are incorporated herein by reference.

### BACKGROUND OF THE INVENTION

1. Field of the Invention

The present invention relates to a descrambling circuit for descrambling scrambled input data, to an error detection code calculating circuit for calculating an error detection code corresponding to the descrambled input data, and a scrambling circuit for scrambling input data.

2. Related Art

Data of DVD is recorded on an ECC block basis. The ECC block is formed by arranging 172-byte data in the row direction to form 192 rows in the column direction. Each row has an additional error correction code called an inner-code parity (PI), while each column has an additional error correction code called an outer-code parity (PO). The data recorded onto the DVD are scrambled, and an error detection code (EDC) is added to each sector as described later.

When reproducing the data recorded onto the DVD, the data are retrieved from the DVD on an ECC block basis. The error correction of PI series is performed on a row basis for the read-out ECC block data, and then the error correction of PO series is performed on partial block data basis, the partial block data being formed by dividing the ECC block data into seven pieces in the column direction. In parallel with the error correction for the PO series, a descrambling process and an EDC calculation process are performed (see JP-A (Kokai) No. 2007-95251).

Since the partial block data are not continuous in the row direction, it is impossible to perform the descrambling process and the EDC calculation process continuously and efficiently. For this reason, there were problems that it takes time to perform the reproducing process of the DVD, and that a circuit for performing the descrambling process and the EDC calculation process cannot be downsized. Similarly, there was also a problem that it takes time to perform a scrambling process and an EDC calculation process when recording data since the partial block data are not continuous.

### SUMMARY OF THE INVENTION

According to one aspect of the present invention, a descrambling circuit comprising:

three or more scramble value generators, each configured to generate a new scramble value by a formula at a state of shifting number of times different from each other by every eight bits based on a predetermined generator polynomial, a scramble value generated by the generator polynomial; and

a descramble unit configured to descramble partially discontinuous scrambled input data by using the scramble values generated by the three or more scramble value generators.

According to one aspect of the present invention, an error detection code calculating circuit comprising:

three or more cumulative adders, each setting an exclusive logical addition of a value obtained by multiplying a first input value by a different degree and a second input value as the first input value at next time; and

an EDC calculating unit configured to calculate an error detection code by using the cumulative adders with respect to the descrambled partially discontinuous scrambled input data.

According to one aspect of the present invention, a scramble circuit comprising:

three or more scramble value generators configured to generate a new scramble value by a formula at a state of shifting number of times different from each other by every eight bits based on a predetermined generator polynomial, the scramble value generated by the generator polynomial; and

a scramble unit configured to scramble input data by using the scramble value generated by the three or more scramble value generators.

### BRIEF DESCRIPTION OF THE DRAWINGS

FIG. 1 is a diagram showing a data format of one sector.

FIG. 2 is a diagram showing a data format of an ECC block.

FIG. 3 is a diagram showing an example where a PO code is arranged to interleave data of twelve rows with one row of the PO code.

FIG. 4 is a diagram showing a data format of a physical sector.

FIG. 5 is a schematic block diagram of an optical disk reproducing device according to a first embodiment of the present invention.

FIG. 6 is a diagram showing an example of partial block data.

FIG. 7 is an operational timing diagram of error correction in the first embodiment.

FIG. 8 is a detailed operational timing diagram of the error correction process for a PO series performed between times t2 and t3 in FIG. 7.

FIG. 9 is a diagram showing an example of a generator polynomial.

FIG. 10 is a detailed block diagram of first to sixth partial blocks of each ECC block.

FIG. 11 is a block diagram showing an example of an internal structure of a descrambling circuit 10.

FIG. 12 is an operational timing diagram showing a descrambling process on the 1st and 2nd rows of the first partial block.

FIG. 13 is an operational timing diagram showing a descrambling process on the last row of the first partial block and the 1st row of the second partial block.

FIG. 14 is an operational timing diagram showing a descrambling process on the last row of the fifth partial block and the last row of the sixth partial block.

FIG. 15 is a block diagram showing an example of an internal structure of an EDC calculating circuit 11.

FIG. 16 is an operational timing diagram showing an EDC calculation process on the 1st and 2nd rows of the first partial block.

FIG. 17 is an operational timing diagram showing an EDC calculation process on the last row of a first sector and the 1st row of a second sector.

FIG. 18 is an operational timing diagram showing an EDC calculation process on the last row of the second sector and the 1st row of the third sector.

FIG. 19 is an operational timing diagram showing an EDC calculation process on the 192nd row of the first partial block and the 1st row of the second partial block.

FIG. 20 is an operational timing diagram showing an EDC calculation process on the last row of the fifth partial block and 1st and 2nd rows of the sixth partial block.

### DETAILED DESCRIPTION OF THE INVENTION

Hereinafter, embodiments of the present invention will be described with reference to the accompanying drawings.

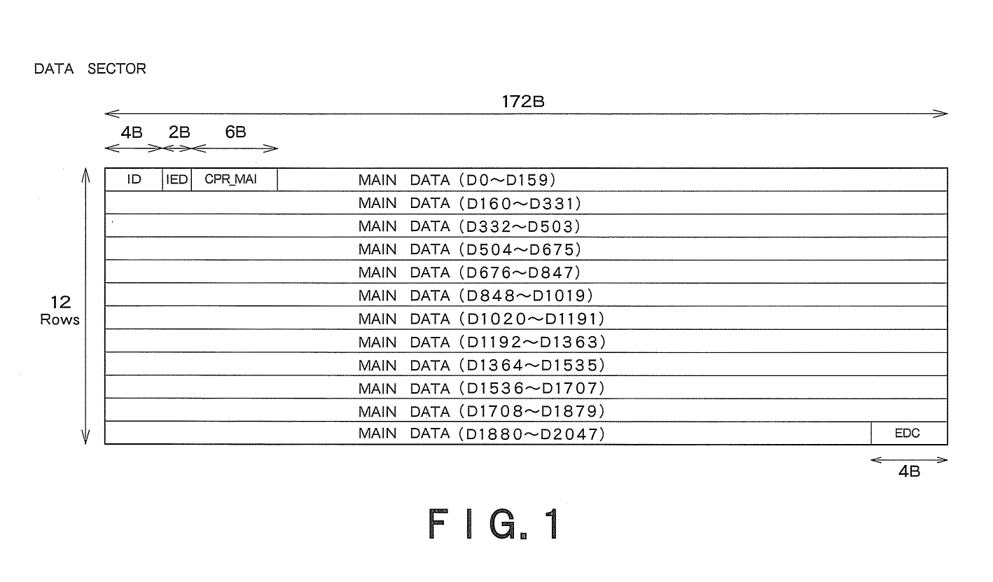

Firstly, a recording format of the DVD will be described. Data recorded onto the DVD are controlled on a sector basis. FIG. 1 is a diagram showing a data format of one sector. One sector is formed by arranging 172 bytes in the row direction (lateral direction) to form twelve rows in the column direction (longitudinal direction). Arranged in the head portion of each sector is ID of 4 bytes expressing a physical address, a parity IED of 2 bytes corresponding to the ID, and copy control data CPR_MAI of 6 bytes, followed by main data of 2048 bytes. An error detection code (EDC) of 4 bytes is added to the end of each sector.

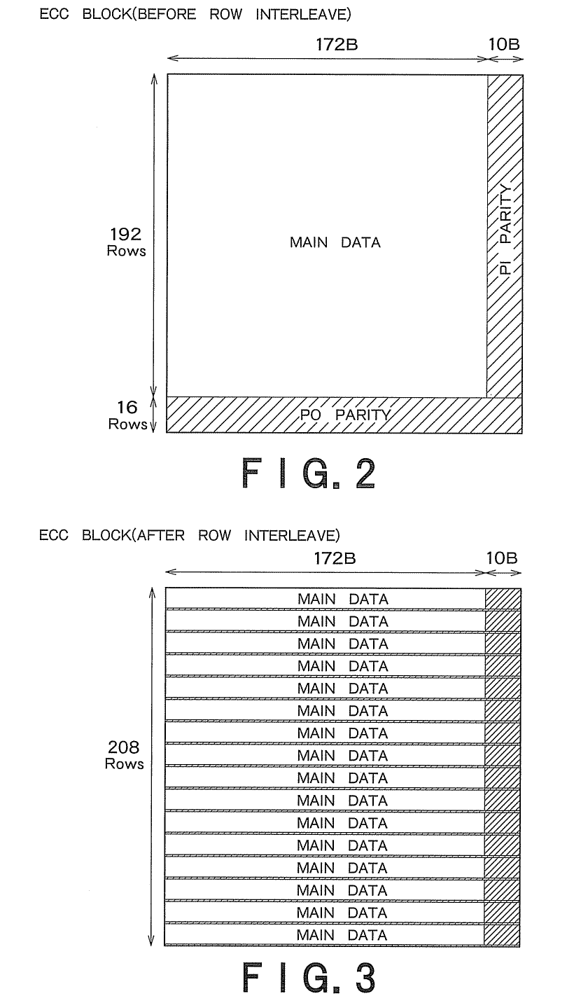

An ECC block is formed by arranging sixteen sectors, each sector being formed as shown in FIG. 1. The ECC block is a unit for writing data onto the optical disk. FIG. 2 is a diagram showing a data format of the ECC block. The ECC block is a two-dimensional array of data with sixteen sectors (16 sectors×12 rows×172 bytes), having data of 172 bytes×192 rows.

In the ECC block, a PI code (RSC (182, 172, 11)) of 10 bytes is added to each row, while a PO code (RSC (208, 192, 17)) of 16 bytes is added to each column. The PI code is an error correction code used to perform error correction on each row corresponding thereto, while the PO code is an error correction code used to perform error correction on each column corresponding thereto.

Actually, as shown in FIG. 3, the PO code is arranged to interleave data of twelve rows with one row of the PO code. In FIG. 3, data of each interleaved row of the ECC block are added with a predetermined synchronous pattern (Sync pattern) and modulated from 8 bits to 16 bits to form a physical sector.

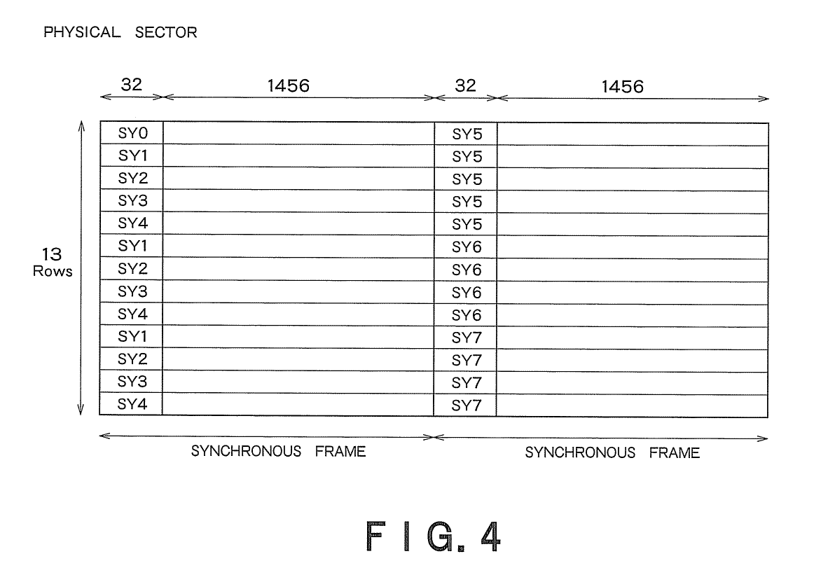

FIG. 4 is a diagram showing a data format of the physical sector. The data of one row (172 bytes+10 bytes=182 bytes) in FIG. 3 are divided into two in the row direction and each divided data are added with a synchronous pattern of 32 bits. Each divided data (182/2=91 bytes) are modulated from 8 bits to 16 bits, which means that 91×16=1456 bits. The last row (the 13th row) of the physical sector is the PO code. A synchronous frame (Sync frame) is generated by adding the synchronous pattern of 32 bits and the divided data of 1456 bits.

When recording the physical sector in FIG. 4 onto the optical disk, each row is scanned from the left to the right to record the data thereof.

### FIRST EMBODIMENT

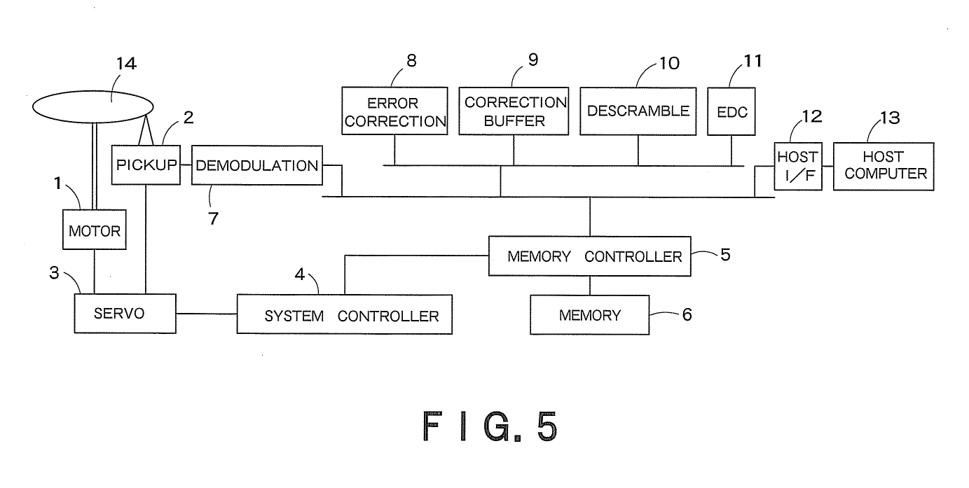

FIG. 5 is a schematic block diagram of an optical disk reproducing device according to a first embodiment of the present invention. An optical disk reproducing device in FIG. 5 comprises a disk motor 1, a pickup 2, a servo processor 3, a system controller 4, a memory controller 5, a memory 6, a demodulator 7, an error corrector 8, a correction buffer 9, a descrambling circuit 10, an EDC calculating circuit 11, a host I/F 12, and a host computer 13.

In accordance with the request from the system controller 4, the servo processor 3 controls the disk motor 1 to rotate an optical disk 14 at a desired speed while controlling the focus position and the track position of the pickup 2 with respect to the optical disk 14.

Reproducing signals retrieved by the pickup 2 from the optical disk 14 are demodulated by the demodulator 7 to be written into the memory 6 through the memory controller 5. The memory 6 is a DRAM, for example.

After reproducing data of one ECC (hereinafter, referred to as one ECC block data) are stored in the memory 6, data of the 1st row of one ECC block data are stored in the correction buffer 9 through the memory controller 5. Hereinafter, it is defined that one ECC block data are formed by arranging M pieces of data (M is an integer of 2 or more) in the row direction (PI code direction) and N pieces of data in the column direction (PO code direction).

The error corrector 8 sequentially performs error correction for the PI series on the first to last rows of the ECC block data transferred to the correction buffer 9. For example, when the error correction is performed on the 1st row, calculation for correcting errors is performed using the PI code included in the 1st row, and if there are any errors, the data of the 1st row in the correction buffer 9 are rewritten to correct the data thereof. While the error corrector 8 is performing the error correction, the memory controller 5 transfers data of the next row from the memory 6 to the correction buffer 9. The error-corrected row data are overwritten in the correction buffer 9.

Afterward, until the error correction for the PI series for one ECC block is finished, the error correction for the PI series by the error corrector 8 and the data transfer on a row basis from the memory 6 to the correction buffer 9 are performed in parallel. Finally, the error-corrected data of one ECC block for the PI series are stored in the correction buffer 9.

Next, the error corrector 8 performs error correction process for the PO series on partial block data, which are formed by arranging L-byte data (note that L is an integer less than M) in the row direction (the PI code direction) and K (an integer of 1 or more) pieces of data in the column direction in one ECC block data in the correction buffer 9 in which the error correction of the PI series is finished.

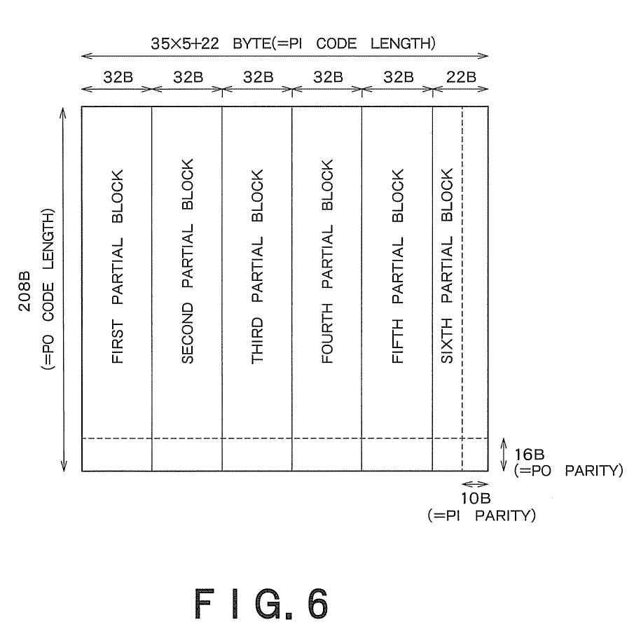

FIG. 6 is a diagram showing an example of the partial block data. In the case of the partial block data in FIG. 6, L=32 or 22. More specifically, there are six partial blocks (first to sixth partial blocks) in one ECC block data. In each of the first to fifth partial blocks, L=32, and in the sixth partial block, L=22. The error corrector 8 sequentially performs the error correction for the PO series on the first to sixth partial block data.

When the error corrector 8 finishes performing the error correction for the PO series on one partial block data, the error corrector 8 retrieves from the correction buffer 9 another partial block data that have not yet performed the error correction, and performs the error correction for the PO series thereon. At the same time, the error-corrected partial block data are transferred to the descrambling circuit 10.

The descrambling circuit 10 descrambles scrambled data on a partial block basis. Subsequently, the EDC calculating circuit 11 calculates an EDC on a sector basis of each partial block using the descrambled data. And then, it is detected whether the calculated EDC is identical with the EDC originally added to the end of each sector.

The descrambled data are stored in the memory 6 through the memory controller 5. The above process is repeated until all the error-corrected data for the PO series corresponding to one ECC block are stored in the memory 6.

After the error correction process for the PO series and the descrambling process for one ECC block are completed, the data are retrieved from the memory 6 through the memory controller 5 at a desired transfer rate to be transferred to the host computer 13 through the host I/F 12.

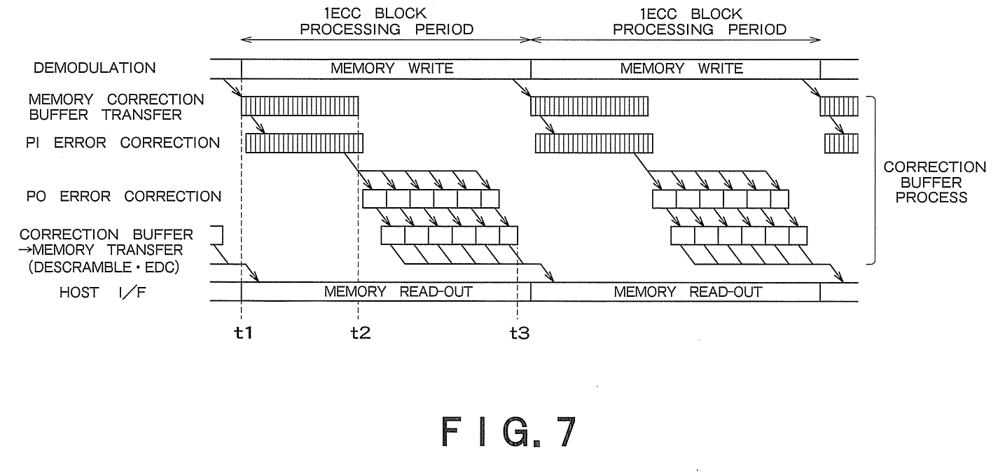

FIG. 7 is an operational timing diagram of error correction in the first embodiment. Firstly, between times to and t2, the data transfer from the memory 6 to the correction buffer 9 and the error correction process for the PI series are performed in parallel. Then, between the time t2 and a time t3, the error correction for the PO series, the descrambling process, the EDC process, and the storage into the memory 6 are performed on a partial block data basis, the partial block data being formed of L×N pieces of data.

When a DRAM is used as the memory 6, it is desirable to assign the row direction (the PI code direction) and the column direction (the PO code direction) in FIG. 6 to the row direction and the column direction of the DRAM, respectively. Since the DRAM can continuously access and retrieve data of multiple columns of the same row without precharging, the data can be retrieved and transferred to the correction buffer 9 at high speed if the data in the PI code direction (the row direction) of one ECC block are stored in the row direction of the DRAM. Further, when the data after the descrambling process and the EDC process are completed are transferred on a partial block data basis to the memory 6, the L-byte data in the row direction can be written at high speed. That is, when the data after the descrambling process and the EDC process are completed are transferred to the memory 6, a process to retrieve L pieces of burst data at high speed may be repeated N times.

In the first embodiment, when the error correction for the PI series is performed, the data are transferred from the memory 6 to the correction buffer 9 on a row basis, so that the data of one ECC block are stored in the correction buffer 9 at the point of starting the error correction for the PO series. Therefore, the error corrector 8 can perform the error correction process for the PO series using the data in the correction buffer 9, making it possible to reduce the number of access to the memory 6. Particularly, if a high-speed memory 6 (SRAM, etc.) is used as the correction buffer 9, the error correction for the PO series can be performed at higher speed.

Note that the size of the data forming the partial block data has no special limitation and can be set arbitrarily. For example, if the partial block data are formed by arranging 26 bytes in the PI code direction to form 208 rows in the PO code direction, seven pieces of partial block data of the same size can be obtained from the formula 182=26×7.

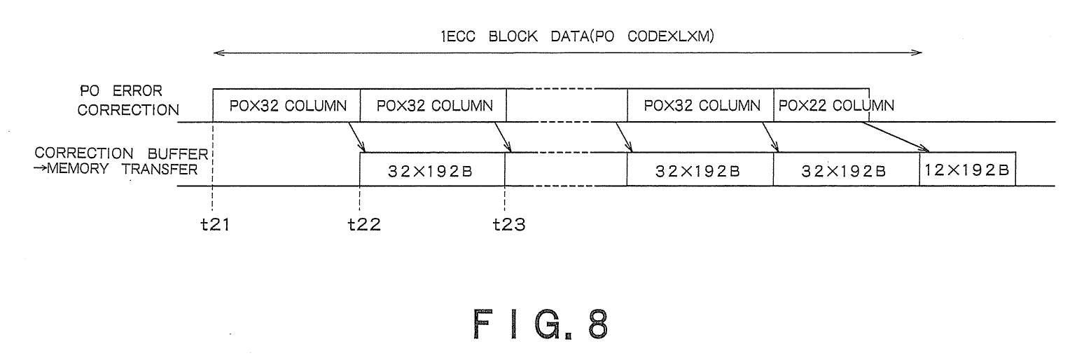

FIG. 8 is a detailed operational timing diagram of the error correction process for the PO series performed between the times t2 and t3 in FIG. 7. Firstly, between times t21 and t22, the error correction for the PO series is performed on the first partial block data, and then, between the time t22 and a time t23, the descrambling process and the EDC process are performed on the error-corrected partial block data, which are stored again in the memory 6 thereafter. Coincidentally with the storage, the error correction for the PO series is performed on the next partial block data.

Note that since the correction buffer 9 in the first embodiment has the memory amount enough to store one ECC block data therein, it is possible that the error-corrected partial block data for the PO series are temporarily retained in the correction buffer 9 and the descrambling process and the EDC process are performed at a delayed timing.

The first embodiment is characterized by the structure of the descrambling circuit 10 and the EDC calculating circuit 11. Firstly, the action principle of the descrambling circuit 10 will be described. In the first embodiment, as shown in FIG. 6, each ECC block is divided into six partial blocks. The descrambling circuit 10 performs on each partial block the descrambling process in parallel with the error correction for the PO series.

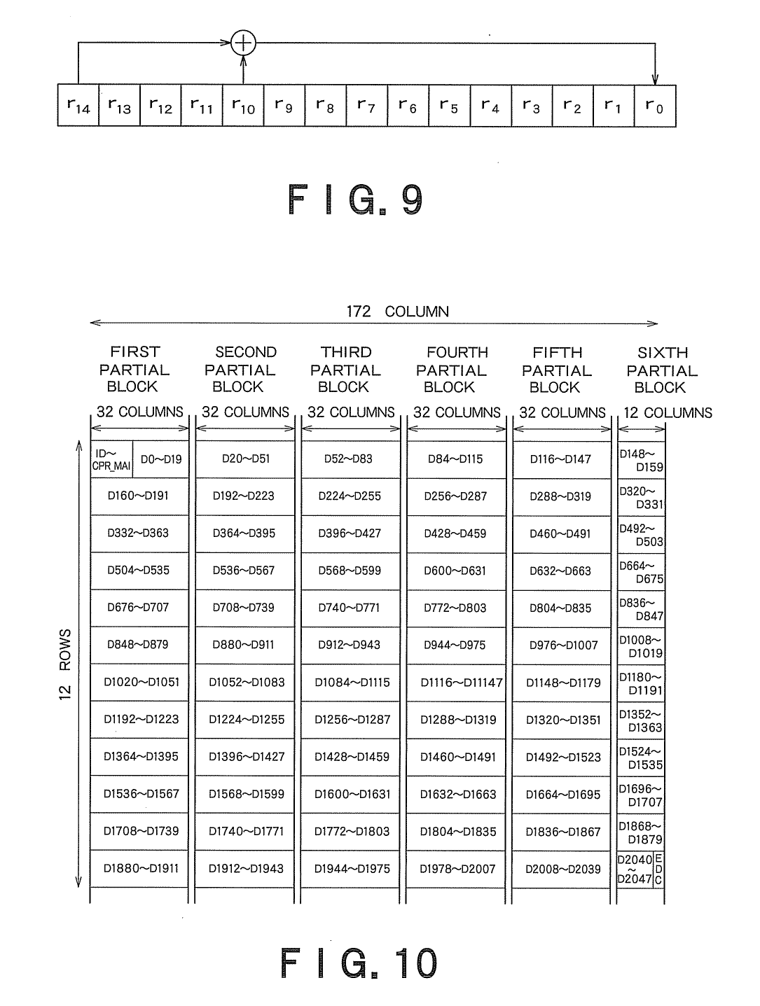

The descrambling circuit 10 descrambles by multiplying scrambled data by a scramble value. The scramble value is calculated by using, for example, a generator polynomial as shown in FIG. 9. The generator polynomial in FIG. 9 has a shift register consisting of fifteen registers from r0 to r14 and feeding back the exclusive logical addition logical addition of the register r10 and r14 to the register r0. A default value of each of the registers r0 to r14 is set depending on the ID of each ECC block. The values of the registers r0 to r7 given with the default values become a scramble value S0 of the first byte of the partial block.

In the generator polynomial in FIG. 9, data is shifted on an 8-bit basis in the direction from r0 to r14, and the values of the registers r0 to r7 obtained every time data is shifted become the scramble value of each of the second and following bytes of the partial block.

When the scrambled input data are Dk and the scramble value is Sk, the scrambled data D′k can be expressed as the following Formula (1). Note that EOR is an exclusive logical addition.

D′k=Dk EOR Sk (k=0˜2047) (1)

FIG. 10 is a detailed block diagram of the first to sixth partial blocks of each ECC block. FIG. 10 shows a data structure of one sector (twelve rows) of each partial block.

As shown in FIG. 10, each of the first to fifth partial blocks has 32 bytes in the column direction, and the sixth partial block has 12 bytes in the column direction. Since ID, IED and CPR_MAI are arranged in the head portion of the first partial block, the data size in the column direction of the first partial block is 20 bytes.

The descrambling circuit 10 performs descrambling process by each row on each partial block on a byte basis. For example, when the descrambling process is performed on the first partial block, the 1st row of 20 bytes are descrambled, then the next row of 32 bytes are descrambled, and each row down to the last row is descrambled in a similar way. When the descrambling process on the first partial blocks is finished, the descrambling process on the second partial block is performed.

In the first to sixth partial blocks, the last byte data of each row and the first byte data of the row next to the each row are discontinuous. Accordingly, when the descrambling process is performed, it is necessary to change the scramble value used in the descrambling process at the point when the data are discontinuous. The scramble value corresponding to the byte data immediately after being discontinuous with the previous byte data depends on the data amount (hereinafter, referred to as discontinuous data amount) existing immediately before and after the point where the data are discontinuous. There are four kinds of the discontinuous data amount as follows.

(1) The discontinuous data amount after the descrambling process is performed on the data of one row (32 bytes) of each of the first to fifth partial blocks is 140 (=172-32) bytes.

(2) The discontinuous data amount after the descrambling process is performed on the data of one row (12 bytes) of the sixth partial block is 160 (=172−12) bytes.

(3) The discontinuous data amount between the first byte of the first partial block and the first byte of the second partial block is 20 bytes.

(4) The discontinuous data amount between the first byte of the second partial block and the first byte of the third partial block, between the first byte of the third partial block and the first byte of the fourth partial block, and between the first byte of the fourth partial block and the first byte of the fifth partial block is 32 bytes.

When the present scramble value is Sk, and the scramble value of n bytes ahead is Sk+n, the scramble value can be expressed as the following Formula (2).

Sk+n=Sk×aⁿ (2)

The scramble value of 32 bytes continuous in the PI code direction of the partial block can be obtained by the process of Sk×a¹. Further, the scramble values at the point where the data are discontinuous due to the change of rows of the partial block can be generated by the processes of Sk×a¹⁴⁰, Sk×a¹⁶⁰, Sk×a²⁰, or Sk×a³².

The scramble value of Sk×a¹ can be obtained by the registers r0 to r7 shifted by 8 bits only once in the generator polynomial in FIG. 9. Similarly, the scramble values of Sk×a¹⁴⁰, Sk×a¹⁶⁰, Sk×a²⁰, and Sk×a³² can be obtained by the registers r0 to r7 shifted by 8 bits 140 times, 160 times, 20 times, and 32 times in the generator polynomial in FIG. 9, respectively.

Since it takes time to perform operation using the generator polynomial in FIG. 9 every time the scramble value is calculated, it is desirable that formulas for the cases where the registers r0 to r7 are shifted by 8 bits once, 140 times, 160 times, 20 times and 32 times in the generator polynomial in FIG. 9 are previously prepared to perform the process at higher speed. These formulas are as follows.

<Formula of ×a¹>

r′14=r6

r′13=r5

r′12=r4

r′11=r3

r′10=r2

r′9=r1

r′8=r0

r′7=r14 EOR r10

r′6=r13 EOR r9

r′5=r12 EOR r8

r′4=r11 EOR r7

r′3=r10 EOR r6

r′2=r9 EOR r5

r′1=r8 EOR r4

r′0=r7 EOR r3 (3)

<Formula of ×a¹⁴⁰>

r′14=r11 EOR r10 EOR r9 EOR r5 EOR r4 EOR r0

r′13=r14 EOR r9 EOR r8 EOR r4 EOR r3

r′12=r13 EOR r8 EOR r7 EOR r3 EOR r2

r′11=r12 EOR r7 EOR r6 EOR r2 EOR r1

r′10=r11 EOR r6 EOR r5 EOR r1 EOR r0

r′9=r14 EOR r5 EOR r4 EOR r0

r′8=r14 EOR r13 EOR r10 EOR r4 EOR r3

r′7=r13 EOR r12 EOR r9 EOR r3 EOR r2

r′6=r12 EOR r11 EOR r8 EOR r2 EOR r1

r′5=r11 EOR r10 EOR r7 EOR r1 EOR r0

r′4=r14 EOR r9 EOR r6 EOR r0

r′3=r14 EOR r13 EOR r10 EOR r8 EOR r5

r′2=r13 EOR r12 EOR r9 EOR r7 EOR r4

r′1=r12 EOR r11 EOR r8 EOR r6 EOR r3

r′0=r11 EOR r10 EOR r7 EOR r5 EOR r2 (4)

<Formula of ×a¹⁶⁰>

r′14=r11 EOR r10 EOR r9 EOR r7 EOR r6 EOR r2 EOR r1 EOR r0

r′13=r14 EOR r9 EOR r8 EOR r6 EOR r5 EOR r1 EOR r0

r′12=r14 EOR r13 EOR r10 EOR r8 EOR r7 EOR r5 EOR r4 EOR r0

r′11=r14 EOR r13 EOR r12 EOR r10 EOR r9 EOR r7 EOR r6 EOR r4 EOR r3

r′10=r13 EOR r12 EOR r11 EOR r9 EOR r8 EOR r6 EOR r5 EOR r3 EOR r2

r′9=r12 EOR r11 EOR r10 EOR r8 EOR r7 EOR r5 EOR r4 EOR r2 EOR r1

r′8=r11 EOR r10 EOR r9 EOR r7 EOR r6 EOR r4 EOR r3 EOR r1 EOR r0

r′7=r14 EOR r9 EOR r8 EOR r6 EOR r5 EOR r3 EOR r2 EOR r0

r′6=r14 EOR r13 EOR r10 EOR r8 EOR r7 EOR r5 EOR r4 EOR r2 EOR r1

r′5=r13 EOR r12 EOR r9 EOR r7 EOR r6 EOR r4 EOR r3 EOR r1 EOR r0

r′4=r14 EOR r12 EOR r11 EOR r10 EOR r8 EOR r6 EOR r5 EOR r3 EOR r2 EOR r0

r′3=r14 EOR r13 EOR r11 EOR r9 EOR r7 EOR r5 EOR r4 EOR r2 EOR r1

r′2=r13 EOR r12 EOR r10 EOR r8 EOR r6 EOR r4 EOR r3 EOR r1 EOR r0

r′1=r14 EOR r12 EOR r11 EOR r10 EOR r9 EOR r7 EOR r5 EOR r3 EOR r2 EOR r0

r′0=r14 EOR r13 EOR r11 EOR r9 EOR r8 EOR r6 EOR r4 EOR r2 EOR r1 (5)

<Formula of ×a²⁰>

r′14=r12 EOR r11 EOR r8 EOR r7 EOR r4 EOR r2 EOR r1

r′13=r11 EOR r10 EOR r7 EOR r6 EOR r3 EOR r1 EOR r0

r′12=r14 EOR r9 EOR r6 EOR r5 EOR r2 EOR r0

r′11=r14 EOR r13 EOR r10 EOR r8 EOR r5 EOR r4 EOR r1

r′10=r13 EOR r12 EOR r9 EOR r7 EOR r4 EOR r3 EOR r0

r′9=r14 EOR r12 EOR r11 EOR r10 EOR r8 EOR r6 EOR r3 EOR r2

r′8=r13 EOR r11 EOR r10 EOR r9 EOR r7 EOR r5 EOR r2 EOR r1

r′7=r12 EOR r10 EOR r9 EOR r8 EOR r6 EOR r4 EOR r1 EOR r0

r′6=r14 EOR r11 EOR r10 EOR r9 EOR r8 EOR r7 EOR r5 EOR r3 EOR r0

r′5=r14 EOR r13 EOR r9 EOR r8 EOR r7 EOR r6 EOR r4 EOR r2

r′4=r13 EOR r12 EOR r8 EOR r7 EOR r6 EOR r5 EOR r3 EOR r1

r′3=r12 EOR r11 EOR r7 EOR r6 EOR r5 EOR r4 EOR r2 EOR r0

r′2=r14 EOR r11 EOR r6 EOR r5 EOR r4 EOR r3 EOR r1

r′1=r13 EOR r10 EOR r5 EOR r4 EOR r3 EOR r2 EOR r0

r′0=r14 EOR r12 EOR r10 EOR r9 EOR r4 EOR r3 EOR r2 EOR r1 (6)

<Formula of ×a³²>

r′14=r13 EOR r8 EOR r5 EOR r0

r′13=r14 EOR r12 EOR r10 EOR r7 EOR r4

r′12=r13 EOR r11 EOR r9 EOR r6 EOR r3

r′11=r12 EOR r10 EOR r8 EOR r5 EOR r2

r′10=r11 EOR r9 EOR r7 EOR r4 EOR r1

r′9=r10 EOR r8 EOR r6 EOR r3 EOR r0

r′8=r14 EOR r10 EOR r9 EOR r7 EOR r5 EOR r2

r′7=r13 EOR r9 EOR r8 EOR r6 EOR r4 EOR r1

r′6=r12 EOR r8 EOR r7 EOR r5 EOR r3 EOR r0

r′5=r14 EOR r11 EOR r10 EOR r7 EOR r6 EOR r4 EOR r2

r′4=r13 EOR r10 EOR r9 EOR r6 EOR r5 EOR r3 EOR r1

r′3=r12 EOR r9 EOR r8 EOR r5 EOR r4 EOR r2 EOR r0

r′2=r14 EOR r11 EOR r10 EOR r8 EOR r7 EOR r4 EOR r3 EOR r1

r′1=r13 EOR r10 EOR r9 EOR r7 EOR r6 EOR r3 EOR r2 EOR r0

r′0=r14 EOR r12 EOR r10 EOR r9 EOR r8 EOR r6 EOR r5 EOR r2 EOR r1 (7)

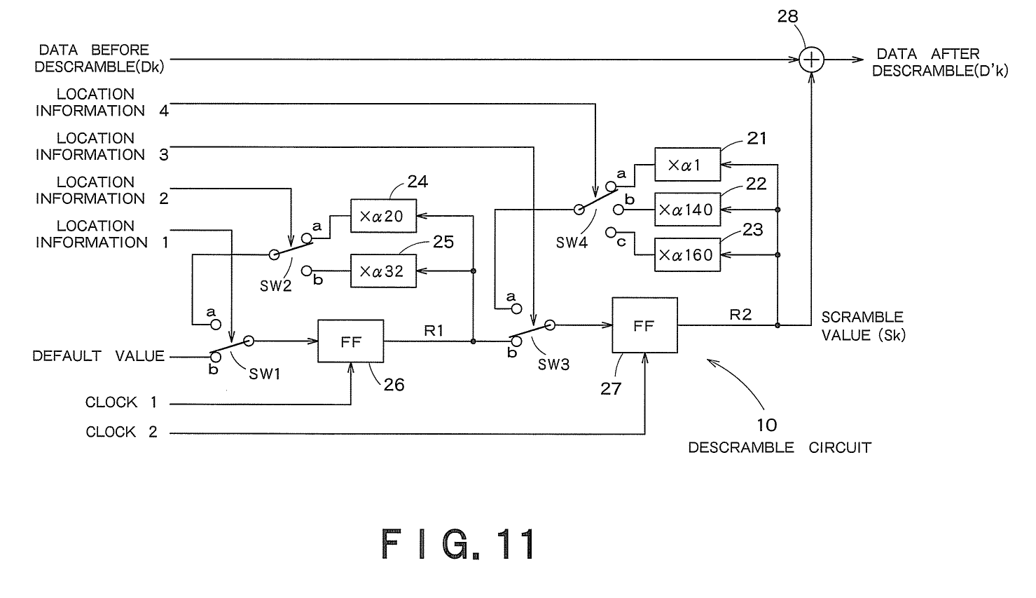

FIG. 11 is a block diagram showing an example of an internal structure of the descrambling circuit 10. The descrambling circuit 10 in FIG. 11 has a first scramble value generator 21 for performing the calculation of ×a¹ as stated above, a second scramble value generator 22 for performing the calculation of ×a¹⁴⁰, a third scramble value generator 23 for performing the calculation of ×a¹⁶⁰, a fourth scramble value generator 24 for performing the calculation of ×a²⁰, a fifth scramble value generator 25 for performing the calculation of ×a³², switches SW1 to SW4, flip-flops (FFs) 26 and 27, and an EOR operator 28.

Each of the first to fifth scramble value generators 21 to 25 corresponds to scramble value generating means. Since all the first to fifth scramble value generators 21 to 25 are not essential, the scramble value generator which is not frequently used can be omitted by previously feeding the scramble values at the discontinuous points as the default values. More specifically, the fourth and fifth scramble value generators 24 and 25, which are less frequently used than the other scramble value generators, can be omitted.

On the other hand, if the first to third scramble value generators 21 to 23 are omitted, it is necessary to feed the default values of scramble values at significant frequency, which enlarge the size of the circuit for generating the default values. Accordingly, the first to third scramble value generators 21 to 23 are essential.

The switch SW4 selects the data output from one of the first to third scramble value generators 21 to 23. The switch SW3 selects one of the data selected by the switch SW4 and the data output from the FF 26. The data selected by the switch SW3 are temporarily stored in the FF 27. Data R2 stored in the FF 27 are fed back to each of the first to third scramble value generators 21 to 23 and are input into the EOR operator 28 as the final scramble value Sk.

The EOR operator 28 calculates the exclusive logical addition of the scrambled input data and the scramble value Sk. The operation result of the EOR operator 28 becomes the descrambled data D′k.

The switch SW2 selects the data output from one of the fourth and fifth scramble value generators 24 and 25. The switch SW1 selects one of the data selected by the switch SW2 and the default value. The data selected by the switch SW1 are temporarily stored in the FF 26.

The default value input into the switch SW1 is a value depending on the address of each sector.

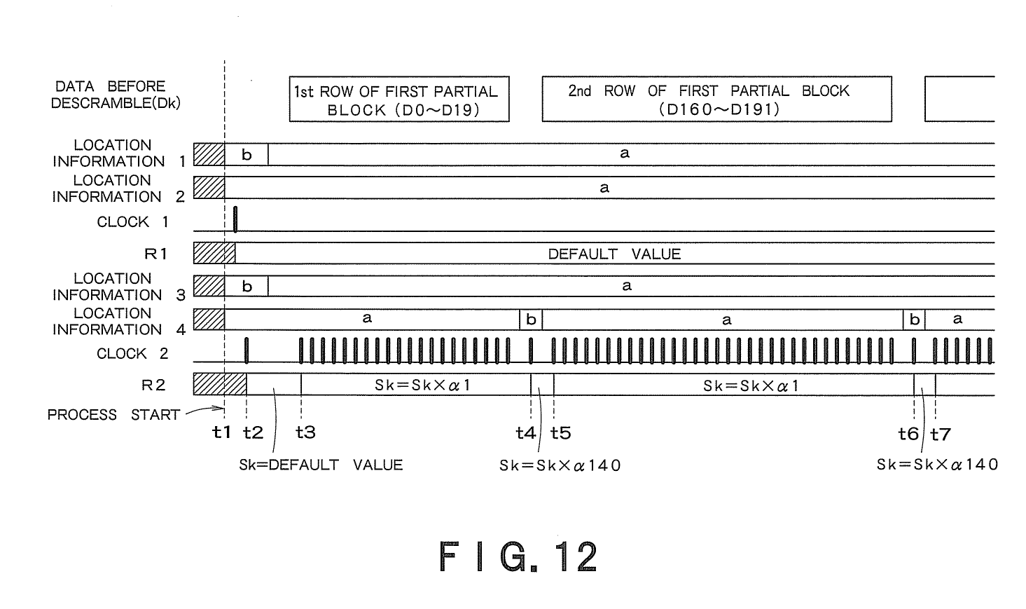

Each of FIGS. 12 to 14 shows an operational timing of the descrambling circuit 10 in FIG. 10. Hereinafter, the action of the descrambling circuit 10 in FIG. 10 will be described using these operational timing diagrams.

FIG. 12 is an operational timing diagram showing a descrambling process on the 1st and 2nd rows of the first partial block. At a time t1, the process is started, and at a time t2, the default value is given. The default value is a 15-bit row in accordance with the generator polynomial in FIG. 9. At this point, the switch SW1 selects the default value, and the FF 26 latches the default value at the edge of a clock 1.

At a time t3, a clock 2 is periodically input into the FF 27, and the first to third scramble value generators 21 to 23 perform calculation in accordance with the formulas of ×a¹, ×a¹⁴⁰, and ×a¹⁶⁰ as stated above, respectively. At this point, the switch SW4 selects the data output from the first scramble value generator 21. The switch SW3 provides the data which is output from the first scramble value generator 21 and are selected by the switch SW4, to each of the first to third scramble value generators 21 to 23.

Until the process for the 1st row of the partial block is finished (between the time t3 and a time t4), the first scramble value generator 21 is selected to generate the scramble value. The scramble value generated is input into each of the first to third scramble value generators 21 to 23, and is also input into the EOR operator 28. The EOR operator 28 calculates the exclusive logical addition of the scrambled input data and the scramble value to perform the descrambling process.

At the time t4, the switch SW4 selects the data output from the second scramble value generator 22, by which the descrambling process on the 2nd row of the partial block is started. Between times t5 and t6, similarly between the times t3 and t4, the first scramble value generator 21 is selected to generate the scramble value.

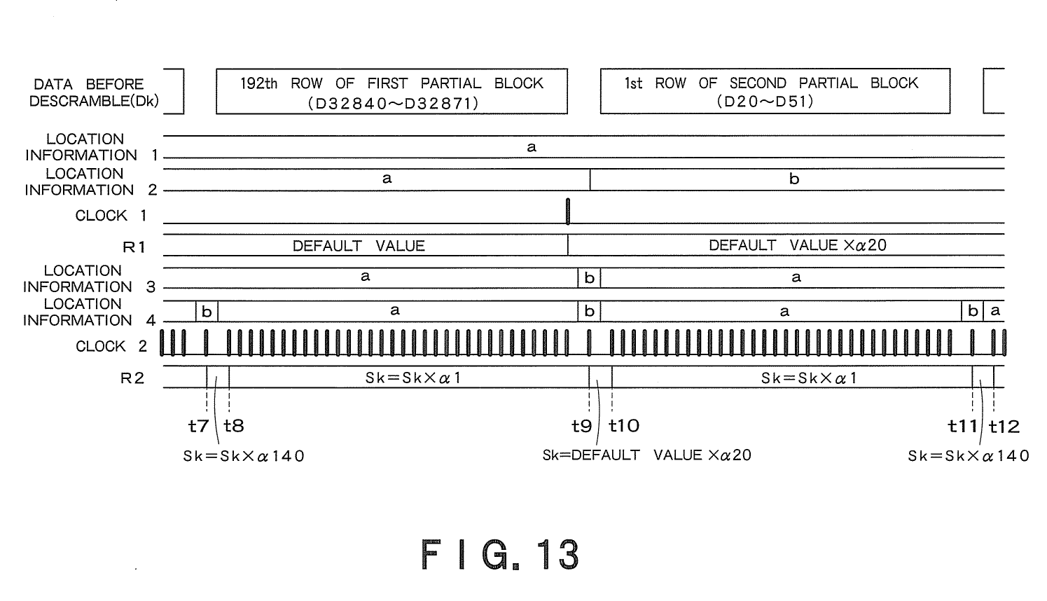

FIG. 13 is an operational timing diagram showing a descrambling process on the last row of the first partial block and the 1st row of the second partial block. At a time t8, the descrambling process on the last row of the first partial block is started. While the descrambling process on the last row is performed (between the time t8 and a time t9), the first scramble value generator 21 is selected to calculate the scramble value. At the time t9, the switches SW2 and SW3 are switched, and the data output from the fourth scramble value generator 24 are latched into the FF 26 through the switch SW2 to be latched into the FF 27 through the switch SW3. This process is performed for the transition from the first partial block to the second partial block.

Then, at a time t10, the descrambling process on the 1st row of the second partial block is started.

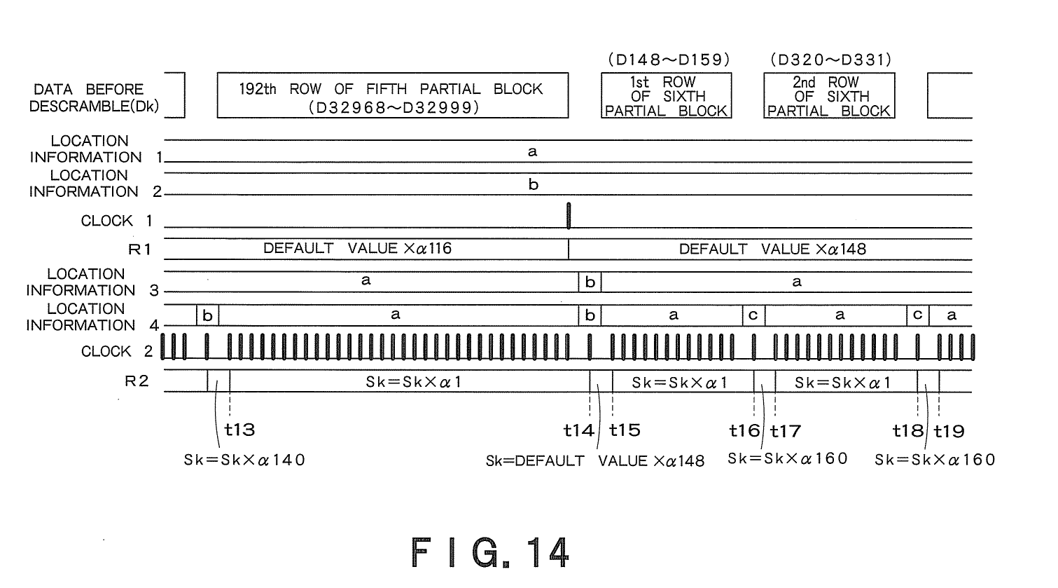

FIG. 14 is an operational timing diagram showing a descrambling process on the last row of the fifth partial block and the head row of the sixth partial block. At a time t13, the descrambling process on the last row of the fifth partial block is started. Between the time t13 and a time t14, the data output from the first scramble value generator 21 are latched into the FF 27 through the switches SW4 and SW3 to generate the scramble value.

At the time t14, the fifth scramble value generator 25 is selected for the transition from the fifth partial block to the sixth partial block.

Then, between times t15 and t16, the data output from the first scramble value generator 21 are latched into the FF 27 through the switches SW4 and SW3 to generate the scramble value.

As stated above, the descrambling circuit 10 has the first to fifth scramble value generators 21 to 25, and a desired scramble value generator is selected in accordance with the data position of the partial block to calculate the scramble value, which makes it possible to calculate the scramble value quickly and to speed up the descrambling process even if the data of the partial block are partially discontinuous.

Next, the EDC calculating circuit 11 will be described. As shown in FIG. 1, the EDC of 4 bytes is added to the end of each sector of the ECC block recorded onto the DVD. When an MSB of the first byte of the sector is b₁₆₅₁₁ and an LSB of the last byte of the sector is b₀, the value of the EDC can be expressed as the following Formula (8).

$$\begin{matrix}[ Mathematical Formula 1 ] & \\ E D C ( x ) = {\sum }_{i = 31}^{0} {b}_{i} {x}^{i} = I ( x ) mod \{ g ( x ) \} & ( 8 )\end{matrix}$$

I(x) and g(x) of Formula (8) can be expressed as Formulas (9) and (10), respectively.

$$\begin{matrix}[ Mathematical Formula 2 ] & \\ I ( x ) = {\sum }_{i = 16511}^{32} {b}_{i} {x}^{i} & ( 9 ) \\ g ( x ) = {x}^{32} + {x}^{31} + {x}^{4} + 1 & ( 10 )\end{matrix}$$

The EDC calculating circuit 11 calculates the EDC with respect to the descrambled input data added with the EDC. When the calculated EDC is identical with the EDC originally added, the calculation result is zero. Accordingly, it is possible to detect easily whether the EDC is correct or not by confirming whether the calculation result of the EDC is zero or not.

When a data bit bₙ is input in the order of decreasing degree, the EDC can be calculated by repeating the operation of the following Formula (11) to perform a cumulative addition every time the data bit bₙ is input.

{bₙ×(x¹)} mod {g(x)} EOR bₙ₋₁ (11)

When the EDC calculation is performed on a partial block basis as shown in FIGS. 6 and 10, the data of each partial block are partially discontinuous, which requires an improvement.

When the data are discontinuous by performing the EDC calculation on a partial block basis, there are three patterns of the degree difference of Formula (11) as follows.

(1) At the point where each row of each partial block changes, the degree difference=x¹³⁷⁶

(2) Between the first and second partial blocks, between the second and third partial blocks, between the third and fourth partial blocks, and between the fourth and fifth partial blocks, the degree difference=x²⁵⁶

(3) Between the fifth and sixth partial blocks, the degree difference=x⁹⁶

The degree 1376 of the above (1) can be obtained with the byte number of one row of the ECC block, namely 172×8 bits=1376 bits. The degree 256 of the above (2) can be obtained with the byte number of the row of each of the first to fifth partial blocks, namely 32 bytes×8 bits=256 bits. The degree 96 of the above (3) can be obtained with the byte number of the row of the sixth partial block, namely 12 bytes×8 bits=96 bits.

With respect to the first to sixth partial blocks, the degree becomes gradually smaller from the first partial block to the sixth partial block. Further, with respect to the sixteen sectors of each partial block, the degree becomes gradually smaller from the first sector to the sixteenth sector.

Based on Formula (11), the cumulative addition is performed on a partial block basis on the cumulative addition values which are obtained by performing the cumulative addition on a row basis on the sector of each partial block of the burst data transferred in the PI code direction, thereby the operation of the EDC value being performed.

When the bits of the input data are r31 to r0 and the bits of the output data are r′31 to r′0, the above Formula (11) when the data are discontinuous can be expressed as follows.

<Formula when the Degree Difference=x¹>

r′31=r31 EOR r30 EOR r29 EOR r28 EOR r27 EOR r26 EOR r25 EOR r24 EOR r23 EOR r22 EOR r21 EOR r20 EOR r19 EOR r18 EOR r17 EOR r16 EOR r15

r′30=r14

r′29=r13

r′28=r12

r′27=r11

r′26=r10

r′25=r9

r′24=r8

r′23=r7

r′22=r6

r′21=r5

r′20=r4

r′19=r31 EOR r3

r′18=r31 EOR r30 EOR r2

r′17=r31 EOR r30 EOR r29 EOR r1

r′16=r31 EOR r30 EOR r29 EOR r28 EOR r0

r′15=r30 EOR r29 EOR r28 EOR r27

r′14=r29 EOR r28 EOR r27 EOR r26

r′13=r28 EOR r27 EOR r26 EOR r25

r′12=r27 EOR r26 EOR r25 EOR r24

r′11=r26 EOR r25 EOR r24 EOR r23

r′10=r25 EOR r24 EOR r23 EOR r22

r′9=r24 EOR r23 EOR r22 EOR r21

r′8=r23 EOR r22 EOR r21 EOR r20

r′7=r22 EOR r21 EOR r20 EOR r19

r′6=r21 EOR r20 EOR r19 EOR r18

r′5=r20 EOR r19 EOR r18 EOR r17

r′4=r19 EOR r18 EOR r17 EOR r16

r′3=r31 EOR r30 EOR r29 EOR r28 EOR r27 EOR r26 EOR r25 EOR r24 EOR r23 EOR r22 EOR r21 EOR r20 EOR r19

r′2=r31 EOR r30 EOR r29 EOR r28 EOR r27 EOR r26 EOR r25 EOR r24 EOR r23 EOR r22 EOR r21 EOR r20 EOR r19 EOR r18

r′1=r31 EOR r30 EOR r29 EOR r28 EOR r27 EOR r26 EOR r25 EOR r24 EOR r23 EOR r22 EOR r21 EOR r20 EOR r19 EOR r18 EOR r17

r′0=r31 EOR r30 EOR r29 EOR r28 EOR r27 EOR r26 EOR r25 EOR r24 EOR r23 EOR r22 EOR r21 EOR r20 EOR r19 EOR r18 EOR r17 EOR r16 (12)

<Formula when the Degree Difference=x⁹⁶>

r′31=r31 EOR r30 EOR r29 EOR r28 EOR r26 EOR r25 EOR r24 EOR r23 EOR r22 EOR r21 EOR r20 EOR r18 EOR r17 EOR r16 EOR r15 EOR r14 EOR r13 EOR r12 EOR r11 EOR r10 EOR r9 EOR r8 EOR r7 EOR r6 EOR r5 EOR r4 EOR r3 EOR r2 EOR r1 EOR r0

r′30=r27 EOR r26 EOR r19 EOR r18

r′29=r26 EOR r25 EOR r18 EOR r17

r′28=r25 EOR r24 EOR r17 EOR r16

r′27=r24 EOR r23 EOR r16 EOR r15

r′26=r23 EOR r22 EOR r15 EOR r14

r′25=r22 EOR r21 EOR r14 EOR r13

r′24=r21 EOR r20 EOR r13 EOR r12

r′23=r20 EOR r19 EOR r12 EOR r11

r′22=r19 EOR r18 EOR r11 EOR r10

r′21=r18 EOR r17 EOR r10 EOR r9

r′20=r17 EOR r16 EOR r9 EOR r8

r′19=r16 EOR r15 EOR r8 EOR r7

r′18=r15 EOR r14 EOR r7 EOR r6

r′17=r14 EOR r13 EOR r6 EOR r5

r′16=r13 EOR r12 EOR r5 EOR r4

r′15=r31 EOR r12 EOR r11 EOR r4 EOR r3

r′14=r30 EOR r11 EOR r10 EOR r3 EOR r2

r′13=r29 EOR r10 EOR r9 EOR r2 EOR r1

r′12=r28 EOR r9 EOR r8 EOR r1 EOR r0

r′11=r31 EOR r27 EOR r8 EOR r7 EOR r0

r′10=r30 EOR r26 EOR r7 EOR r6

r′9=r29 EOR r25 EOR r6 EOR r5

r′8=r28 EOR r24 EOR r5 EOR r4

r′7=r31 EOR r27 EOR r23 EOR r4 EOR r3

r′6=r30 EOR r26 EOR r22 EOR r3 EOR r2

r′5=r29 EOR r25 EOR r21 EOR r2 EOR r1

r′4=r28 EOR r24 EOR r20 EOR r1 EOR r0

r′3=r30 EOR r29 EOR r28 EOR r27 EOR r26 EOR r25 EOR r24 EOR r22 EOR r21 EOR r20 EOR r19 EOR r18 EOR r17 EOR r16 EOR r15 EOR r14 EOR r13 EOR r12 EOR r11 EOR r10 EOR r9 EOR r8 EOR r7 EOR r6 EOR r5 EOR r4 EOR r3 EOR r2 EOR r1

r′2=r31 EOR r29 EOR r28 EOR r27 EOR r26 EOR r25 EOR r24 EOR r23 EOR r21 EOR r20 EOR r19 EOR r18 EOR r17 EOR r16 EOR r15 EOR r14 EOR r13 EOR r12 EOR r11 EOR r10 EOR r9 EOR r8 EOR r7 EOR r6 EOR r5 EOR r4 EOR r3 EOR r2 EOR r1 EOR r0

r′1=r31 EOR r30 EOR r28 EOR r27 EOR r26 EOR r25 EOR r24 EOR r23 EOR r22 EOR r20 EOR r19 EOR r18 EOR r17 EOR r16 EOR r15 EOR r14 EOR r13 EOR r12 EOR r11 EOR r10 EOR r9 EOR r8 EOR r7 EOR r6 EOR r5 EOR r4 EOR r3 EOR r2 EOR r1 EOR r0

r′0=r31 EOR r30 EOR r29 EOR r27 EOR r26 EOR r25 EOR r24 EOR r23 EOR r22 EOR r21 EOR r19 EOR r18 EOR r17 EOR r16 EOR r15 EOR r14 EOR r13 EOR r12 EOR r11 EOR r10 EOR r9 EOR r8 EOR r7 EOR r6 EOR r5 EOR r4 EOR r3 EOR r2 EOR r1 EOR r0 (13)

<Formula when the degree difference=x²⁵⁶>

r′31=r31 EOR r30 EOR r28 EOR r26 EOR r25 EOR r24 EOR r23 EOR r14 EOR r13 EOR r12 EOR r11 EOR r10 EOR r9 EOR r8 EOR r7

r′30=r29 EOR r28 EOR r27 EOR r26 EOR r22 EOR r14 EOR r6

r′29=r28 EOR r27 EOR r26 EOR r25 EOR r21 EOR r13 EOR r5

r′28=r27 EOR r26 EOR r25 EOR r24 EOR r20 EOR r12 EOR r4

r′27=r31 EOR r26 EOR r25 EOR r24 EOR r23 EOR r19 EOR r11 EOR r3

r′26=r31 EOR r30 EOR r25 EOR r24 EOR r23 EOR r22 EOR r18 EOR r10 EOR r2

r′25=r31 EOR r30 EOR r29 EOR r24 EOR r23 EOR r22 EOR r21 EOR r17 EOR r9 EOR r1

r′24=r31 EOR r30 EOR r29 EOR r28 EOR r23 EOR r22 EOR r21 EOR r20 EOR r16 EOR r8 EOR r0

r′23=r30 EOR r29 EOR r28 EOR r27 EOR r22 EOR r21 EOR r20 EOR r19 EOR r15 EOR r7

r′22=r29 EOR r28 EOR r27 EOR r26 EOR r21 EOR r20 EOR r19 EOR r18 EOR r14 EOR r6

r′21=r28 EOR r27 EOR r26 EOR r25 EOR r20 EOR r19 EOR r18 EOR r17 EOR r13 EOR r5

r′20=r27 EOR r26 EOR r25 EOR r24 EOR r19 EOR r18 EOR r17 EOR r16 EOR r12 EOR r4

r′19=r31 EOR r26 EOR r25 EOR r24 EOR r23 EOR r18 EOR r17 EOR r16 EOR r15 EOR r1 EOR r3

r′18=r31 EOR r30 EOR r25 EOR r24 EOR r23 EOR r22 EOR r17 EOR r16 EOR r15 EOR r14 EOR r10 EOR r2

r′17=r31 EOR r30 EOR r29 EOR r24 EOR r23 EOR r22 EOR r21 EOR r16 EOR r15 EOR r14 EOR r13 EOR r9 EOR r1

r′16=r31 EOR r30 EOR r29 EOR r28 EOR r23 EOR r22 EOR r21 EOR r20 EOR r15 EOR r14 EOR r13 EOR r12 EOR r8 EOR r0

r′15=r30 EOR r29 EOR r28 EOR r27 EOR r22 EOR r21 EOR r20 EOR r19 EOR r14 EOR r13 EOR r12 EOR r11 EOR r7

r′14=r29 EOR r28 EOR r27 EOR r26 EOR r21 EOR r20 EOR r19 EOR r18 EOR r13 EOR r12 EOR r11 EOR r10 EOR r6

r′13=r28 EOR r27 EOR r26 EOR r25 EOR r20 EOR r19 EOR r18 EOR r17 EOR r12 EOR r11 EOR r10 EOR r9 EOR r5

r′12=r27 EOR r26 EOR r25 EOR r24 EOR r19 EOR r18 EOR r17 EOR r16 EOR r11 EOR r10 EOR r9 EOR r8 EOR r4

r′11=r31 EOR r26 EOR r25 EOR r24 EOR r23 EOR r18 EOR r17 EOR r16 EOR r15 EOR r10 EOR r9 EOR r8 EOR r7 EOR r3

r′10=r31 EOR r30 EOR r25 EOR r24 EOR r23 EOR r22 EOR r17 EOR r16 EOR r15 EOR r14 EOR r9 EOR r8 EOR r7 EOR r6 EOR r2

r′9=r31 EOR r30 EOR r29 EOR r24 EOR r23 EOR r22 EOR r21 EOR r16 EOR r15 EOR r14 EOR r13 EOR r8 EOR r7 EOR r6 EOR r5 EOR r1

r′8=r31 EOR r30 EOR r29 EOR r28 EOR r23 EOR r22 EOR r21 EOR r20 EOR r15 EOR r14 EOR r13 EOR r12 EOR r7 EOR r6 EOR r5 EOR r4 EOR r0

r′7=r31 EOR r30 EOR r29 EOR r28 EOR r27 EOR r22 EOR r21 EOR r20 EOR r19 EOR r14 EOR r13 EOR r12 EOR r11 EOR r6 EOR r5 EOR r4 EOR r3

r′6=r30 EOR r29 EOR r28 EOR r27 EOR r26 EOR r21 EOR r20 EOR r19 EOR r18 EOR r13 EOR r12 EOR r11 EOR r10 EOR r5 EOR r4 EOR r3 EOR r2

r′5=r31 EOR r29 EOR r28 EOR r27 EOR r26 EOR r25 EOR r20 EOR r19 EOR r18 EOR r17 EOR r12 EOR r11 EOR r10 EOR r9 EOR r4 EOR r3 EOR r2 EOR r1

r′4=r30 EOR r28 EOR r27 EOR r26 EOR r25 EOR r24 EOR r19 EOR r18 EOR r17 EOR r16 EOR r11 EOR r10 EOR r9 EOR r8 EOR r3 EOR r2 EOR r1 EOR r0

r′3=r30 EOR r29 EOR r28 EOR r27 EOR r18 EOR r17 EOR r16 EOR r15 EOR r14 EOR r13 EOR r12 EOR r11 EOR r2 EOR r1 EOR r0

r′2=r31 EOR r29 EOR r28 EOR r27 EOR r26 EOR r17 EOR r16 EOR r15 EOR r14 EOR r13 EOR r12 EOR r11 EOR r10 EOR r1 EOR r0

r′1=r30 EOR r28 EOR r27 EOR r26 EOR r25 EOR r16 EOR r15 EOR r14 EOR r13 EOR r12 EOR r11 EOR r10 EOR r9 EOR r0

r′0=r31 EOR r29 EOR r27 EOR r26 EOR r25 EOR r24 EOR r15 EOR r14 EOR r13 EOR r12 EOR r11 EOR r10 EOR r9 EOR r8 (14)

<Formula when the Degree Difference=x¹³⁷⁶>

r′31=r31 EOR r30 EOR r28 EOR r26 EOR r25 EOR r24 EOR r23 EOR r22 EOR r21 EOR r20 EOR r19

r′30=r29 EOR r28 EOR r27 EOR r26 EOR r18

r′29=r28 EOR r27 EOR r26 EOR r25 EOR r17

r′28=r27 EOR r26 EOR r25 EOR r24 EOR r16

r′27=r26 EOR r25 EOR r24 EOR r23 EOR r15

r′26=r25 EOR r24 EOR r23 EOR r22 EOR r14

r′25=r24 EOR r23 EOR r22 EOR r21 EOR r13

r′24=r23 EOR r22 EOR r21 EOR r20 EOR r12

r′23=r22 EOR r21 EOR r20 EOR r19 EOR r11

r′22=r21 EOR r20 EOR r19 EOR r18 EOR r10

r′21=r20 EOR r19 EOR r18 EOR r17 EOR r9

r′20=r19 EOR r18 EOR r17 EOR r16 EOR r8

r′19=r18 EOR r17 EOR r16 EOR r15 EOR r7

r′18=r17 EOR r16 EOR r15 EOR r14 EOR r6

r′17=r16 EOR r15 EOR r14 EOR r13 EOR r5

r′16=r15 EOR r14 EOR r13 EOR r12 EOR r4

r′15=r31 EOR r14 EOR r13 EOR r12 EOR r11 EOR r3

r′14=r31 EOR r30 EOR r13 EOR r12 EOR r11 EOR r10 EOR r2

r′13=r31 EOR r30 EOR r29 EOR r12 EOR r11 EOR r10 EOR r9 EOR r1

r′12=r31 EOR r30 EOR r29 EOR r28 EOR r11 EOR r10 EOR r9 EOR r8 EOR r0

r′11=r30 EOR r29 EOR r28 EOR r27 EOR r10 EOR r9 EOR r8 EOR r7

r′10=r29 EOR r28 EOR r27 EOR r26 EOR r9 EOR r8 EOR r7 EOR r6

r′9=r28 EOR r27 EOR r26 EOR r25 EOR r8 EOR r7 EOR r6 EOR r5

r′8=r27 EOR r26 EOR r25 EOR r24 EOR r7 EOR r6 EOR r5 EOR r4

r′7=r31 EOR r26 EOR r25 EOR r24 EOR r23 EOR r6 EOR r5 EOR r4 EOR r3

r′6=r30 EOR r25 EOR r24 EOR r23 EOR r22 EOR r5 EOR r4 EOR r3 EOR r2

r′5=r31 EOR r29 EOR r24 EOR r23 EOR r22 EOR r21 EOR r4 EOR r3 EOR r2 EOR r1

r′4=r30 EOR r28 EOR r23 EOR r22 EOR r21 EOR r20 EOR r3 EOR r2 EOR r1 EOR r0

r′3=r30 EOR r29 EOR r28 EOR r27 EOR r26 EOR r25 EOR r24 EOR r23 EOR r2 EOR r1 EOR r0

r′2=r31 EOR r29 EOR r28 EOR r27 EOR r26 EOR r25 EOR r24 EOR r23 EOR r22 EOR r1 EOR r0

r′1=r30 EOR r28 EOR r27 EOR r26 EOR r25 EOR r24 EOR r23 EOR r22 EOR r21 EOR r0

r′0=r31 EOR r29 EOR r27 EOR r26 EOR r25 EOR r24 EOR r23 EOR r22 EOR r21 EOR r20 (15)

If a circuit for performing the operation of the above Formulas (12) to (15) is previously prepared, it is not necessary to perform the calculation using Formula (11) every time the data are input, which makes it possible to calculate the EDC value at high speed.

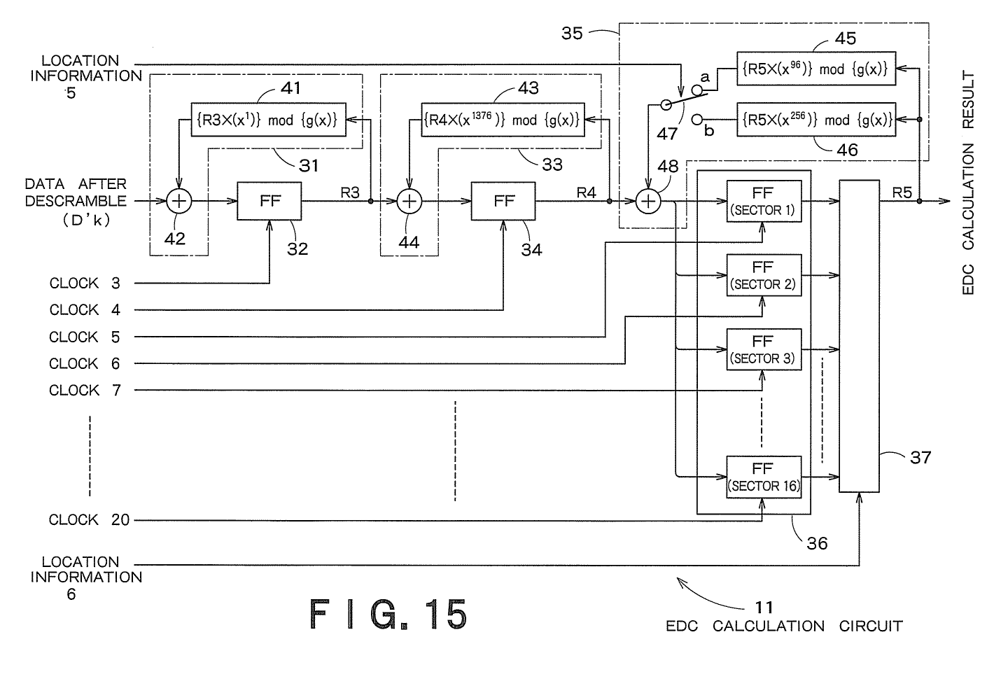

FIG. 15 is a block diagram showing an example of an internal structure of the EDC calculating circuit 11. The EDC calculating circuit 11 in FIG. 15 is characterized in that a circuit for performing the calculation of the above Formulas (12) to (15) is previously prepared.

The EDC calculating circuit 11 in FIG. 15 has a first cumulative adder 31 for performing the cumulative addition of the degree difference X¹ as stated above, a flip-flop (FF) 32 for temporarily storing the cumulative addition value of the first cumulative adder 31, a second cumulative adder 33 for performing the cumulative addition of the degree difference X¹³⁷⁶, a flip-flop (FF) 34 for temporarily storing the cumulative addition value of the second cumulative adder 33, a third cumulative adder 35 for performing the cumulative addition of the degree difference X²⁵⁶ or X⁹⁶, a flip-flop (FF) 36 for temporarily storing the cumulative addition value on a sector basis, and the sector selector 37.

The first cumulative adder 31 has an X¹ calculator 41 for calculating the above Formula (12), and an EOR operator 42 for calculating the exclusive logical addition of the calculation result of the X¹ calculator 41 and the descrambled data. The second cumulative adder 33 has an X¹³⁷⁶ calculator 43 for calculating the above Formula (15), and an EOR operator 44 for calculating the exclusive logical addition of the calculation result of the X¹³⁷⁶ calculator 43 and the cumulative addition value of the first cumulative adder 31.

The third cumulative adder 35 has an X⁹⁶ calculator 45 for calculating the above Formula (13), an X²⁵⁶ calculator 46 for calculating the above Formula (14), a switch 47 for selecting one of the calculation result of the X⁹⁶ calculator 45 and the calculation result of the X²⁵⁶ calculator 46, and an EOR operator 48 for performing the operation of the exclusive logical addition of the calculation result selected by the switch 47 and the cumulative addition value of the second cumulative adder 33.

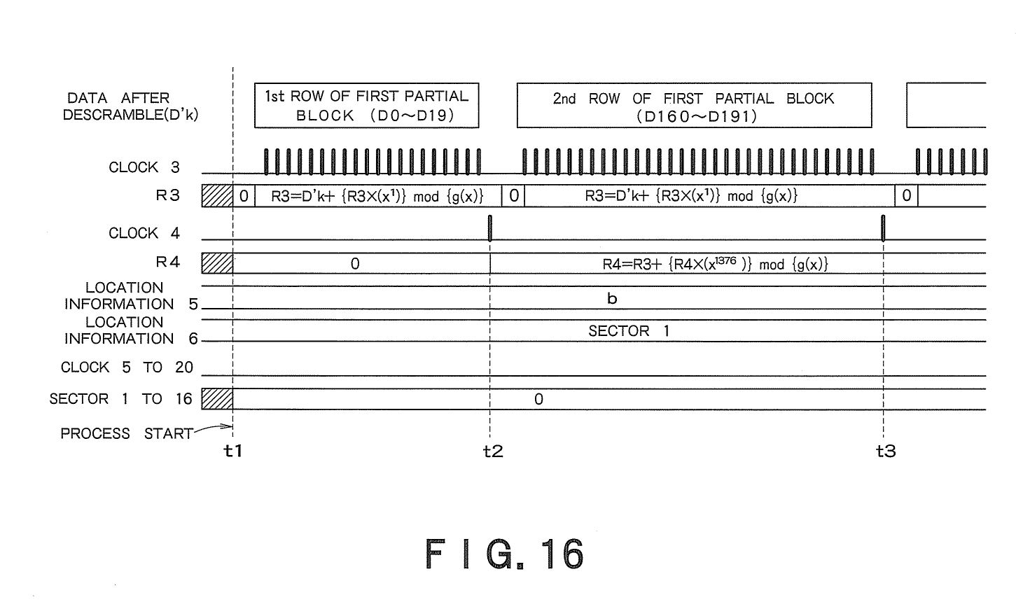

Each of FIGS. 16 to 20 is an operational timing diagram of the EDC calculating circuit 11 in FIG. 15. Hereinafter, the action of the EDC calculating circuit 11 in FIG. 15 will be described using these operational timing diagrams.

FIG. 16 is an operational timing diagram showing an EDC calculation process on the 1st and 2nd rows of the first partial block. At a time t1, the process is started, and the byte data of the descrambled 1st row are synchronized with a clock 3 and are taken into the first cumulative adder 31 to calculate the cumulative addition value.

At a time t2, a clock 4 is applied to the second cumulative adder 33, and the second cumulative adder 33 performs the cumulative addition only once.

Then, the byte data of the 2nd row of the first partial block are sequentially synchronized with the clock 3 and are taken into the first cumulative adder 31 to calculate the cumulative addition value.

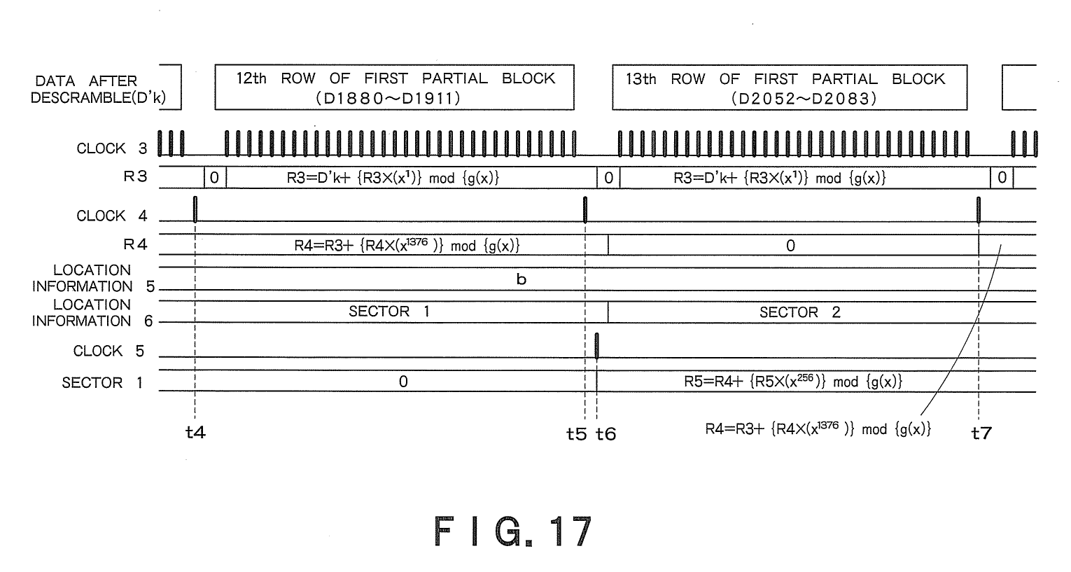

FIG. 17 is an operational timing diagram showing an EDC calculation process on the 12th and 13th rows of the first partial block (the last row of the first sector and the 1st row of the second sector). After a time t4, the byte data of the 12th row of the first partial block are sequentially synchronized with the clock 3 and are taken into the first cumulative adder 31 to calculate the cumulative addition value.

At a time t5, the clock 4 is applied to the second cumulative adder 33, and the second cumulative adder 33 performs the cumulative addition only once.

Then, at a time t6, the clock 5 is applied to the FF 36 of the first sector, and the total cumulative addition value output from the second cumulative adder 33 is stored in the FF 36 of the first sector. Stored in the FF 36 is the cumulative addition value of the first sector.

Between times t6 and t7, the byte data of the 1st row of the second sector, namely the 13th row of the first partial block, are sequentially synchronized with the clock 3 and are taken into the first cumulative adder 31 to calculate the cumulative addition value.

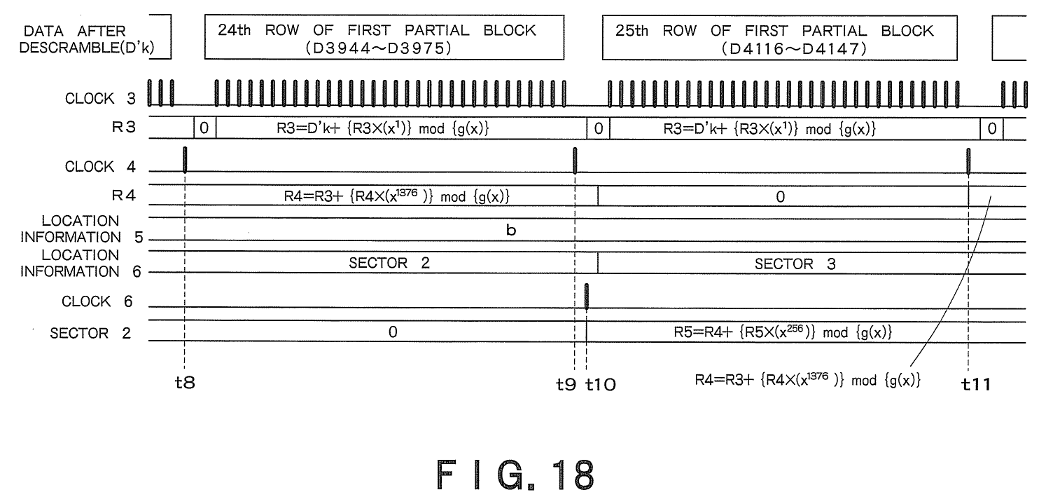

FIG. 18 is an operational timing diagram showing an EDC calculation process on the 24th and 25th rows of the second partial block (the last row of the second sector and the 1st row of the third sector). Between times t8 and t9, the byte data of the 24th row of the first partial block are sequentially synchronized with the clock 3 and are taken into the first cumulative adder 31 to calculate the cumulative addition value.

At a time t9, the clock 4 is applied to the second cumulative adder 33, and the second cumulative adder 33 performs the cumulative addition only once.

Then, at a time t10, a clock 6 is applied to the FF 36 of the second sector, and the total cumulative addition value output from the second cumulative adder 33 is stored in the FF 36 of the second sector. Stored in the FF 36 is the cumulative addition value of the second sector.

Between times t10 and t11, the byte data of the 1st row of the third sector, namely the 25th row of the first partial block, are sequentially synchronized with the clock 3 and are taken into the first cumulative adder 31 to calculate the cumulative addition value.

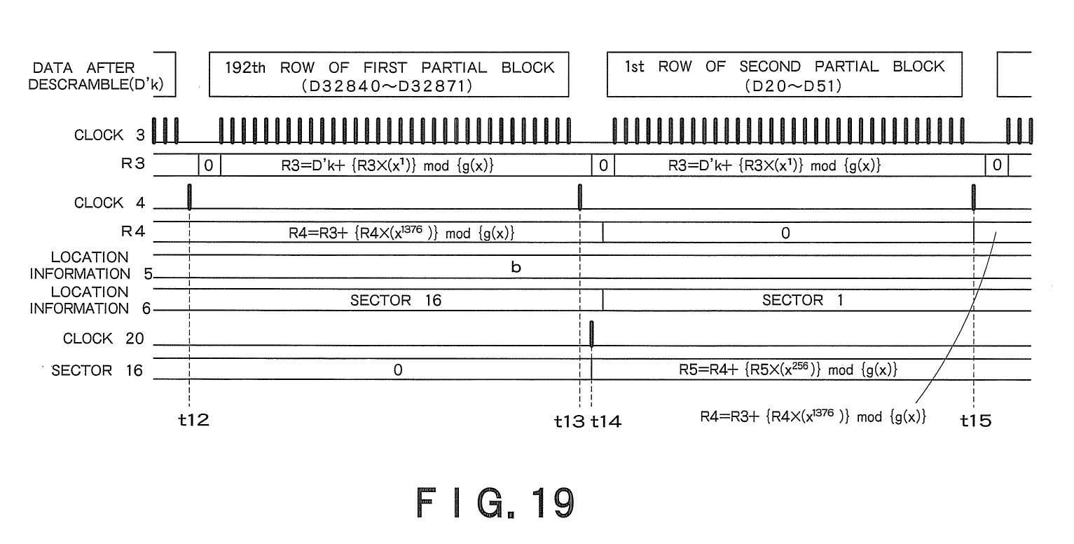

FIG. 19 is an operational timing diagram showing an EDC calculation process on the 192nd row (the last row) of the first partial block and the 1st row of the second partial block. Between times t12 and t13, the byte data of the last row of the first partial block are sequentially synchronized with the clock 3 and are taken into the first cumulative adder 31 to calculate the cumulative addition value.

At a time t13, the clock 4 is applied to the second cumulative adder 33, and the second cumulative adder 33 performs the cumulative addition only once.

Then, at a time t14, a clock 20 is applied to the FF 36 of the sixteenth sector, and the total cumulative addition value output from the second cumulative adder 33 is stored in the FF 36 of the sixteenth sector. Stored in the FF 36 is the cumulative addition value of the sixteenth sector.

Between the time t14 and a time t15, the byte data of the 1st row of the second partial block are sequentially synchronized with the clock 3 and are taken into the first cumulative adder 31 to calculate the cumulative addition value.

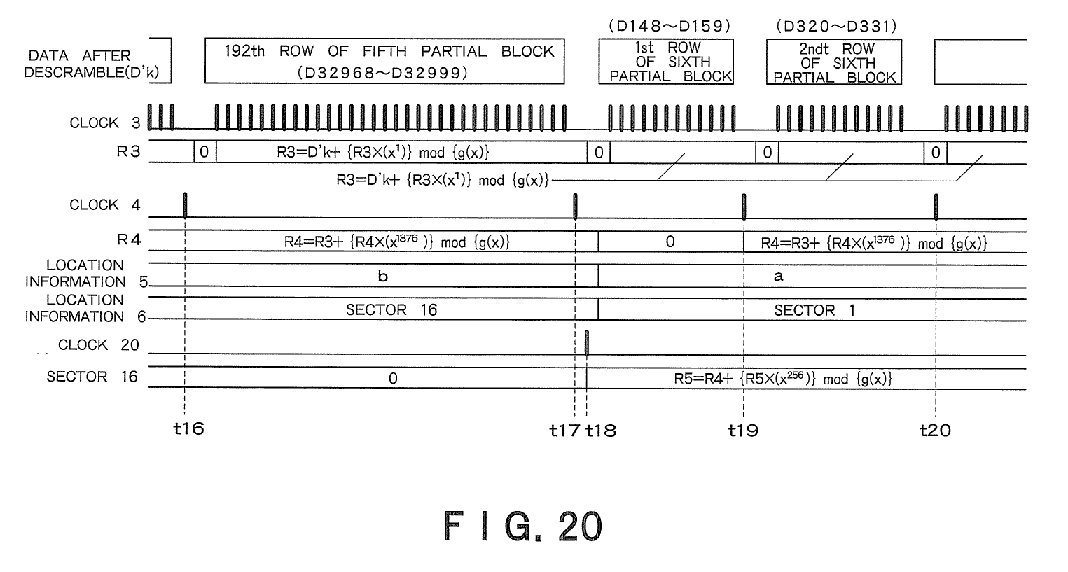

FIG. 20 is an operational timing diagram showing an EDC calculation process on the last row of the fifth partial block and 1st and 2nd rows of the sixth partial block. Between times t16 and t17, the byte data of the last row of the fifth partial block are sequentially synchronized with the clock 3 and are taken into the first cumulative adder 31 to calculate the cumulative addition value.

At a time t17, the clock 4 is applied to the second cumulative adder 33, and the second cumulative adder 33 performs the cumulative addition only once.

Then, at a time t18, the clock 20 is applied to the FF 36 of the sixteenth sector, and the total cumulative addition value output from a fifth cumulative adder is stored in the FF 36. Stored in the FF 36 is the cumulative addition value of the sixteenth sector.

Then, at a time t19, the second cumulative adder 33 performs the operation of the cumulative addition value of the 1st row of the sixth partial block, and at a time t20, the second cumulative adder 33 performs the operation of the cumulative addition value of the 2nd row of the sixth partial block.

Since the data input into the EDC calculating circuit 11 in FIG. 15 contains the EDC with respect to each sector as shown in FIG. 1, when the EDC process is performed normally, the output from the EDC calculating circuit 11 in FIG. 15 is zero. Accordingly, it is possible to judge quickly whether the EDC calculation process is performed normally by confirming whether the output is zero or not.

As stated above, the EDC calculating circuit 11 has the first to third cumulative adders 35, and a desired cumulative adder is selected in accordance with the data position of the partial block, which makes it possible to calculate the EDC quickly and to speed up the EDC calculation process even if the data of the partial block are partially discontinuous.

### SECOND EMBODIMENT

Although the descrambling process and the EDC calculation process when reproducing the data recorded onto the DVD have been described in the first embodiment as stated above, the present invention can also be applied to a scrambling process and an EDC calculation process when recording data onto the DVD.

A scrambling circuit for performing the scrambling process when recording data is formed to be similar to the circuit in FIG. 11, and an EDC calculating circuit for performing the EDC calculation process when recording data is formed to be similar to the circuit in FIG. 15. More specifically, when the scrambling circuit is formed, the data that are not scrambled are input into the circuit in FIG. 11.

The scrambling circuit and the EDC calculating circuit when recording data can be operated in parallel. The EDC calculated by the EDC calculating circuit is added to the scrambled data calculated by the scrambling circuit on a sector basis.

As stated above, in the scrambling circuit and the EDC calculating circuit used when recording data, the scrambling process and the EDC calculation can be performed at high speed on a partial block basis, even if each partial block has discontinuous data.

1. A descrambling circuit comprising:
three or more scramble value generators, each configured to generate a new scramble value by a formula at a state of shifting number of times different from each other by every eight bits based on a predetermined generator polynomial, a scramble value generated by the generator polynomial; and
a descramble unit configured to descramble partially discontinuous scrambled input data by using the scramble values generated by the three or more scramble value generators.

2. The descrambling circuit according to claim 1,
wherein the partially discontinuous scrambled input data is sorted into a plurality of partial blocks in a column direction, each partial block including L (L is an integer of one or more) byte in the column direction and K (K is an integer of one or more) byte in a row direction, data being written in units of a block including the plurality of partial blocks;
the scramble value generator generates the scramble values corresponding to the input data in sequence by each partial block; and
the descramble unit descrambles the input data in the corresponding partial block by using the scramble value generated by the scramble value generator by each partial block.

3. The descrambling circuit according to claim 2,
wherein the scramble value generator includes:
a first scramble value generator configured to generate a new scramble value by a formula at a state of shifting once by every eight bits based on the generator polynomial, the scramble value generated by the generator polynomial;
a second scramble value generator configured to generate a new scramble value by a formula at a state of shifting number of times corresponding to one row of the partial block, the scramble value generated by the generator polynomial by every eight bits based on the generator polynomial; and
a third scramble value generator configured to generate a new scramble value by a formula at a state of shifting number of times corresponding to a neighboring partial block by every eight bits based on the generator polynomial, the scramble value generated by the generator polynomial.

4. The descrambling circuit according to claim 3,
wherein the scramble value generator includes:
a fourth scramble value generator configured to generate a new scramble value by a formula at a state of shifting number of times corresponding to bytes between a head portion of a head partial block and a head portion of a partial block neighboring to the head partial block by every eight bits based on the generator polynomial, the scramble value generated by the generator polynomial; and
a fifth scramble value generator configured to generate a new scramble value by a formula at a state of shifting number of times corresponding to bytes between head portions of neighboring two partial blocks except for the head partial block in the block by every eight bits based on the generator polynomial, the scramble value generated by the generator polynomial.

5. An error detection code calculating circuit comprising:
three or more cumulative adders, each setting an exclusive logical addition of a value obtained by multiplying a first input value by a different degree and a second input value as the first input value at next time; and
an EDC calculating unit configured to calculate an error detection code by using the cumulative adders with respect to the descrambled partially discontinuous scrambled input data.

6. The error detection code calculating circuit according to claim 5, wherein:
the partially discontinuous input data is sorted into a plurality of partial blocks in a column direction, each partial block including L (L is an integer of one or more) byte in the column direction and K (K is an integer of one or more) byte in a row direction, data being written in units of a block including the plurality of partial blocks; and
the EDC calculating unit cumulatively adds values obtained by performing cumulative additions by each row of each partial block on a partial block basis to calculate the error detection code on a sector basis.

7. The error detection code calculating circuit according to claim 6, wherein the three or more cumulative adders includes:
a first cumulative adder configured to set an exclusive logical addition of a value obtained by multiplying a first input value by a degree corresponding to one row of the block and a second input value as the first input value at next time;
a second cumulative adder configured to set an exclusive logical addition of a value obtained by multiplying a first input value by a degree corresponding to one row width of the block and a second input value as the first input value at next time; and
a third cumulative adder configured to set an exclusive logical addition of a value obtained by multiplying a first input value by a degree corresponding to one row width of the last partial block in the block and a second input value as the first input value at next time.

8. The error detection code calculating circuit according to claim 7, wherein the three or more cumulative adders include a fourth cumulative adder configured to set an exclusive logical addition of a value obtained by multiplying a first input value by a degree corresponding to a neighboring data in the partial block and a second input value as the first input value at next time.

9. A scrambling circuit comprising:
three or more scramble value generators configured to generate a new scramble value by a formula at a state of shifting number of times different from each other by every eight bits based on a predetermined generator polynomial, the scramble value generated by the generator polynomial; and
a scramble unit configured to scramble input data by using the scramble value generated by the three or more scramble value generators.

10. The scrambling circuit according to claim 9,
wherein the input data is sorted into a plurality of partial blocks in a column direction, each partial block including L (L is an integer of one or more) byte in the column direction and K (K is an integer of one or more) byte in a row direction, data being written in units of a block including the plurality of partial blocks;
the scramble value generator generates the scramble values corresponding to the input data in sequence by each partial block; and
the scramble unit scrambles the input data in the corresponding partial block by using the scramble value generated by the scramble value generator by each partial block.

11. The scrambling circuit according to claim 10,
wherein the scramble value generator includes:
a first scramble value generator configured to generate a new scramble value by a formula at a state of shifting once by every eight bits based on the generator polynomial, the scramble value generated by the generator polynomial;
a second scramble value generator configured to generate a new scramble value by a formula at a state of shifting number of times corresponding to one row of the partial block by every eight bits based on the generator polynomial, the scramble value generated by the generator polynomial; and
a third scramble value generator configured to generate a new scramble value by a formula at a state of shifting number of times corresponding to a neighboring partial block by every eight bits based on the generator polynomial, the scramble value generated by the generator polynomial.

12. The scrambling circuit according to claim 11,
wherein the scramble value generator includes:
a fourth scramble value generator configured to generate a new scramble value by a formula at a state of shifting number of times corresponding to bytes between a head portion of a head partial block in the block and a head portion of a partial block neighboring to the head partial block by every eight bits based on the generator polynomial, the scramble value generated by the generator polynomial; and
a fifth scramble value generator configured to generate a new scramble value by a formula at a state of shifting number of times corresponding bytes between head portions of neighboring two partial blocks except for the head partial block in the block by every eight bits based on the generator polynomial, the scramble value generated by the generator polynomial.

13. The scrambling circuit according to claim 9, further comprising an error detection code calculating circuit,
the error detection code calculating circuit includes:
three or more cumulative adders, each setting an exclusive logical addition of a value obtained by multiplying a first input value by a different degree and a second input value as the first input value at next time; and
an EDC calculating unit configured to calculate an error detection code by using the cumulative adders with respect to the input data.

14. The scrambling circuit according to claim 13, wherein:
the input data is sorted into a plurality of partial blocks in a column direction, each partial block including L (L is an integer of one or more) byte in the column direction and K (K is an integer of one or more) byte in a row direction, data being written in units of a block including the plurality of partial blocks; and
the EDC calculating unit cumulatively adds values obtained by performing cumulative additions by each row of each partial block on a partial block basis to calculate the error detection code on a sector basis.

15. The scrambling circuit according to claim 14, wherein the three or more cumulative adders includes:
a first cumulative adder configured to set an exclusive logical addition of a value obtained by multiplying a first input value by a degree corresponding to one row of the block and a second input value as the first input value at next time;
a second cumulative adder configured to set an exclusive logical addition of a value obtained by multiplying a first input value by a degree corresponding to a row width of the partial block and a second input value as the first input value at next time; and
a third cumulative adder configured to set an exclusive logical addition of a value obtained by multiplying a first input value by a degree corresponding to a row width of the last partial block in the block and a second input value as the first input value at next time.

16. The scrambling circuit according to claim 15, wherein the three or more cumulative adders include a fourth cumulative adder configured to set an exclusive logical addition of a value obtained by multiplying a first input value by a degree corresponding to a neighboring data in the partial block and a second input value as the first input value at next time.
